(19) United States
(12) Patent Application Publication
(10) Pub. No.: US 2024/0330076 A1
(43) Pub. Date: Oct. 3, 2024

(54) Task Allocation with Chipset Attached Memory and Additional Processing Unit

(71) Applicant: Advanced Micro Devices, Inc., Santa Clara, CA (US)

(72) Inventors: Jerry Anton Ahrens, Sister Bay, WI (US); William Robert Alverson, Del Valle, TX (US); Joshua Taylor Knight, Georgetown, TX (US); Amitabh Mehra, Fort Collins, CO (US); Anil Harwani, Austin, TX (US); Grant Evan Ley, Eden, UT (US)

(73) Assignee: Advanced Micro Devices, Inc., Santa Clara, CA (US)

(21) Appl. No.: 18/190,521

(22) Filed: Mar. 27, 2023

(51) Int. Cl. G06F 9/50

(52) U.S. Cl. CPC G06F 9/5094; G06F 9/5016; G06F 9/5033

(57) ABSTRACT

Task allocation with chipset attached memory and additional processing unit is described. In accordance with the described techniques, a computing device includes a main system and one or more sub-systems which are coupled to the main system via a chipset link. The main system includes at least a processing unit and a system memory. The one or more sub-systems each include at least a chipset attached processing unit and a chipset attached memory. Contents of the system memory are transferable to the chipset attached memory of the sub-system via the chipset link to enable the chipset attached processing unit to perform the one or more tasks using the contents from the chipset attached memory.

### BACKGROUND

Computer games and other applications are regularly advancing, resulting in larger programs, higher resolution graphics, new features, and so forth. To address these advances, computer hardware is also advancing to provide new types of memory having faster data rates, faster clock rates, and so forth.

### BRIEF DESCRIPTION OF THE DRAWINGS

FIG. 1 is an illustration of a non-limiting example system that allocates tasks to be performed to a chipset attached memory and additional processing unit.

FIG. 2 depicts a non-limiting example in which tasks are allocated to a chipset attached processing unit located across a chipset link from a system memory.

FIG. 3 depicts a procedure in an example implementation of task allocation with chipset attached memory and additional processing unit.

FIG. 4 is an illustration of another non-limiting example system that employs a chipset attached memory and additional processing unit for task allocation.

FIG. 5 is an illustration of another non-limiting example system employs a chipset attached memory and additional processing unit for task allocation.

### DETAILED DESCRIPTION

### Overview

Task allocation with chipset attached memory and additional processing unit is described. In accordance with the described techniques, a system includes a main system and one or more sub-systems. The main system, for example, includes at least a system memory, a processing unit, and a memory controller. The main system is configured or otherwise operable to allocate tasks to the one or more sub-systems which are separate from the main system. Each of the one or more sub-systems, for example, includes a chipset attached processing unit, a chipset attached memory, and a chipset attached memory controller. The chipset attached memory is physical memory managed by an application or program other than an operating system running on the processing unit of the main system. Notably, the chipset attached memory is separate from the system memory, which allows the chipset attached memory to be used in various manners, such as to speed up access to frequently used data, without reducing the amount of system memory available to an operating system running on the processing unit of the main system.

The separate architecture allows the chipset attached processing unit to execute or otherwise perform the tasks using the chipset attached memory and the chipset attached memory controller, without using the main system. In at least one variation, tasks are allocated to the chipset attached processing unit and the chipset attached memory rather than to the processing unit and the system memory based on power consumption and/or computational complexity of the tasks. In one implementation, for example, tasks that consume less power (and/or other computing resources) and/or are less computationally complex are allocated to the chipset attached processing unit and the chipset attached memory, whereas tasks that consume more power (and/or other resources) and/or are more computationally complex (e.g., “power hungry” tasks) are allocated to the processing unit and the system memory.

By allocating tasks to sub-systems instead of the main system, power (and other resources) provided to the main system to operate it can be reduced while the sub-system that includes the chipset attached processing unit performs the tasks using the chipset attached memory and the chipset attached processing unit. In one or more implementations, for instance, the main processing unit and/or the main system memory are power gated so that those components are offline (e.g., completely powered down) while the chipset attached processing unit performs at least one of the tasks. In this way, the main processing unit and the main system memory consume less power (e.g., they do not consume any power) while the system continues to run using the chipset attached processing unit and the chipset attached memory.

In some aspects, the techniques described herein relate to an apparatus including: a main system that includes at least a processing unit and a system memory, a sub-system that includes a chipset attached processing unit and a chipset attached memory, wherein the chipset attached processing unit is configured to perform one or more tasks using the chipset attached memory, and a chipset link that couples the main system to the sub-system.

In some aspects, the techniques described herein relate to an apparatus, wherein contents of the system memory are transferable to the chipset attached memory of the sub-system via the chipset link to enable the chipset attached processing unit to perform the one or more tasks using the contents from the chipset attached memory.

In some aspects, the techniques described herein relate to an apparatus, wherein the main system further includes a memory controller, wherein the memory controller is configured to signal the system memory to transfer the contents to the chipset attached memory.

In some aspects, the techniques described herein relate to an apparatus, wherein the processing unit and the system memory are power gated while the chipset attached processing unit performs the one or more tasks using the chipset attached memory.

In some aspects, the techniques described herein relate to an apparatus, wherein the power gating causes the main system to be completely shut off while the chipset attached processing unit performs the one or more tasks using the chipset attached memory.

In some aspects, the techniques described herein relate to an apparatus, wherein the power gating causes the main system to operate in a reduced power mode while the chipset attached processing unit performs the one or more tasks using the chipset attached memory.

In some aspects, the techniques described herein relate to an apparatus, wherein the processing unit is configured to perform additional tasks using additional contents from the system memory while the chipset attached processing unit performs the one or more tasks using the chipset attached memory.

In some aspects, the techniques described herein relate to an apparatus, wherein the one or more tasks are allocated to the chipset attached processing unit and the chipset attached memory based on a power consumption of the one or more tasks.

In some aspects, the techniques described herein relate to an apparatus, wherein the one or more tasks are allocated to the chipset attached processing unit and the chipset attached memory based on a computational complexity of the one or more tasks.

In some aspects, the techniques described herein relate to an apparatus, wherein the one or more tasks are allocated to the chipset attached processing unit and the chipset attached memory based on a list which specifies types of tasks to be allocated to the chipset attached processing unit and the chipset attached memory.

In some aspects, the techniques described herein relate to an apparatus, further including at least one additional sub-system that includes at least an additional chipset attached processing unit and an additional chipset attached memory, wherein the additional chipset attached processing unit is configured to perform one or more additional tasks using the additional chipset attached memory.

In some aspects, the techniques described herein relate to a method including: transferring contents of a system memory to a chipset attached memory, the contents transferred over a chipset link from a source side of the chipset link that includes the system memory to a destination side of the chipset link that includes the chipset attached memory, performing, by a chipset attached processing unit on the destination side of the chipset link, one or more tasks using the contents transferred to the chipset attached memory, and while the one or more tasks are performed by the chipset attached processing unit on the destination side of the chipset link, power-gating the source side of the chipset link that includes the system memory.

In some aspects, the techniques described herein relate to a method, further including: powering on the source side that includes the system memory; and performing, by a processing unit included on the source side, one or more additional tasks using the contents of the system memory.

In some aspects, the techniques described herein relate to a method, wherein performing the one or more tasks by the chipset attached processing unit on the destination side of the chipset link reduces power consumption.

In some aspects, the techniques described herein relate to a system including: a processing unit, a system memory; a chipset attached processing unit, a chipset attached memory, and a memory controller, wherein the memory controller is configured to initiate a transfer of contents stored in the system memory to the chipset attached memory.

In some aspects, the techniques described herein relate to a system, wherein the chipset attached processing unit is configured to perform one or more tasks using the contents of the chipset attached memory.

In some aspects, the techniques described herein relate to a system, wherein the processing unit and the system memory are power gated while the chipset attached processing unit performs the one or more tasks using the chipset attached memory.

In some aspects, the techniques described herein relate to a system, wherein the power gating causes the processing unit and the system memory to be completely shut off while the chipset attached processing unit performs the one or more tasks using the chipset attached memory.

In some aspects, the techniques described herein relate to a system, further including a chipset link, wherein the memory controller is configured to transfer the contents stored in the system memory to the chipset attached memory via the chipset link.

In some aspects, the techniques described herein relate to a system, wherein the memory controller is further configured to allocate tasks to the chipset attached processing unit and the chipset attached memory based on a power consumption or computational complexity of the tasks.

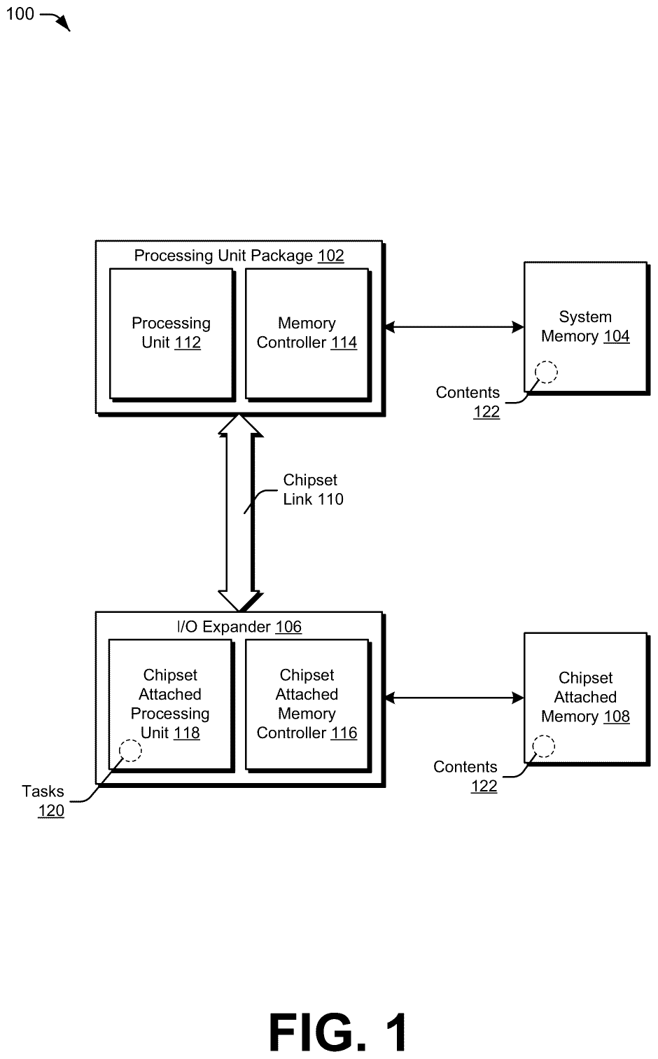

FIG. 1 is an illustration of a non-limiting example system 100 that allocates tasks to be performed to a chipset attached memory and additional processing unit. The system 100 includes a processing unit package 102, a system memory 104, an I/O expander 106, a chipset attached memory 108, and a chipset link 110. The processing unit package 102, the system memory 104, the I/O expander 106, the chipset attached memory 108, and the chipset link 110 are installed on or are part of, for example, a motherboard or other printed circuit board. In one or more implementations, the I/O expander 106 (including the chipset attached memory controller 116 and the chipset attached processing unit 118), the chipset link 110, one or more memory channels between the processing unit package 102 and the system memory 104, and one or more memory channels between the I/O expander 106 and the chipset attached memory 108 are also referred to as a chipset of a motherboard or other printed circuit board. In one or more variations, the chipset link 110 is routed entirely on the motherboard itself. In one or more other variations, the I/O expander 106 (including the chipset attached memory controller 116 and the chipset attached processing unit 118) and the chipset attached memory 108 are implemented on an add in card that is connected to the motherboard via one or more sockets.

The processing unit package 102 includes a processing unit 112 and a memory controller 114. The processing unit 112 is any of various processing units, such as a central processing unit (CPU), a graphics processing unit (GPU), an Accelerated Processing Unit (APU), a parallel accelerated processor, a digital signal processor, an artificial intelligence (AI) or machine learning accelerator, and so forth. Although a single processing unit 112 is illustrated in the system 100, the processing unit package 102 optionally includes any number of processing units of the same or different types.

The system memory 104 is any of a variety of types of physical RAM. Examples of system memory 104 include dynamic random-access memory (DRAM), phase-change memory (PCM), memristors, static random-access memory (SRAM), and so forth. The system memory 104 is coupled or attached to the processing unit package 102 via one or more memory channels. The system memory 104 is packaged or configured in any of a variety of different manners. Examples of such packaging or configuring include a dual in-line memory module (DIMM), a small outline DIMM (SO-DIMM), a registered DIMM (RDIMM), a non-volatile DIMM (NVDIMM), a ball grid array (BGA) memory permanently attached to (e.g., soldered to) the motherboard (or other printed circuit board), and so forth.

Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR5) SDRAM. In at least one variation, the system memory 104 is configured as or includes a SO-DIMM or an RDIMM according to one of the above-mentioned standards, e.g., DDR, DDR2, DDR3, DDR4, and DDR5.

Further examples of memory configurations include low-power double data rate (LPDDR), also known as LPDDR SDRAM, which is a type of synchronous dynamic random-access memory. In variations, LPDDR consumes less power than other types of memory and/or has a form factor suitable for mobile computers and devices, such as mobile phones. Examples of LPDDR include, but are not limited to, low-power double data rate 2 (LPDDR2), low-power double data rate 3 (LPDDR3), low-power double data rate 4 (LPDDR4), and low-power double data rate 5 (LPDDR5). It is to be appreciated that the system memory 104 is configurable in a variety of ways without departing from the spirit or scope of the described techniques.

The memory controller 114 manages access to the system memory 104, such as by sending read and write requests (i.e., “access requests”) to the system memory 104 and receiving responses (i.e., “serviced requests”) from the system memory 104. In one or more implementations, the system memory 104 is the main physical memory of an apparatus that is managed by an operating system running on the processing unit 112 (e.g., a CPU of the apparatus), such as by allocating portions of the system memory 104 to applications running on the processing unit 112, managing virtual memory spaces and memory pages for applications running on the processing unit 112, and so forth. In one or more implementations, the memory controller 114 is configured as a microcontroller disposed on a die (e.g., corresponding to processing unit package 102 and/or the system memory 104) running firmware to perform a variety of the operations discussed above and below. In variations, the memory controller 114 is configured differently, such as in hardware and/or software.

The processing unit package 102 optionally includes one or more additional controllers to link to additional devices, such as a Peripheral Component Interconnect Express (PCIe) controller, a Serial Advanced Technology Attachment (SATA) controller, a Universal Serial Bus (USB) controller, a Serial Peripheral Interface (SPI) controller, a Low Pin Count (LPC) controller, and so forth. Additionally or alternatively, one or more of these additional controllers is implemented separately from the processing unit package 102, such as in a chip (e.g., an integrated circuit optionally referred to as a northbridge) that is part of the chipset of a motherboard or other printed circuit board.

The processing unit package 102 communicates with the I/O expander 106 via the chipset link 110. The chipset link 110 is any of a variety of communication links, such as a high-speed bus. In one example, the chipset link 110 is one or more PCIe lanes.

The I/O expander 106 includes a chipset attached memory controller 116 and a chipset attached processing unit 118. In one or more implementations, the chipset attached memory controller 116 configured as a microcontroller disposed on a die (e.g., corresponding to the I/O expander 106) running firmware to perform a variety of the operations discussed above and below. In variations, the chipset attached memory controller 116 is configured differently, such as in hardware and/or software. The I/O expander 106 optionally includes or is coupled to one or more additional controllers to link to other devices, such as a PCIe controller, a SATA controller, a USB controller, an SPI controller, an LPC controller, and so forth. In one or more implementations, the I/O expander 106 is referred to as a southbridge.

The chipset attached memory controller 116 manages access to the chipset attached memory 108, such as by sending read and write requests (i.e., access requests) to the chipset attached memory 108 and receiving responses (i.e., serviced requests) from the chipset attached memory 108. The chipset attached memory 108 is referred to as “chipset attached” due to the chipset attached memory 108 being attached to the I/O expander 106 rather than the processing unit package 102 directly, and due to the chipset attached memory 108 being controlled by a memory controller of the I/O expander 106 rather than a memory controller of the processing unit package 102. The chipset attached memory 108 is coupled or attached to the I/O expander 106 via one or more memory channels.

In accordance with the described techniques, the I/O expander 106 also includes a chipset attached processing unit 118. Examples of the chipset attached processing unit 118 include one or more of, but are not limited to, a processor core, a field programmable gate array (FPGA), and an efficiency dense core, to name just a few. Alternatively or in addition, a central processing unit (CPU), a graphics processing unit (GPU), an Accelerated Processing Unit (APU), a parallel accelerated processor, a digital signal processor, an artificial intelligence (AI) or machine learning accelerator, and so forth. Although a single chipset attached processing unit 118 is illustrated in the system 100, the I/O expander 106 optionally includes any number of processing units of the same or different types.

In one or more implementations, the chipset attached processing unit 118 is substantially identical to the processing unit 112—the chipset attached processing unit 118 is a same or similar type of processing unit that is attached to a different portion of the system 100 from the portion to which the processing unit 112 is attached. In one or more implementations, the chipset attached processing unit 118 differs from the processing unit 112 in at least one characteristic, such that the difference in the at least one characteristic is taken advantage of by allocating one or more tasks to the processing unit 112 for performance and allocating one or more additional tasks (e.g., different tasks) to the chipset attached processing unit 118 for performance. As examples of different characteristics, in one or more implementations, the chipset attached processing unit 118 is relatively efficient or dense in relation to the processing unit 112. In other examples, the chipset attached processing unit 118 has different characteristics which differentiate it from the processing unit 112. The chipset attached processing unit 118 is configurable in various ways without departing from the spirit or scope of the described techniques.

The chipset attached processing unit 118 is referred to as “chipset attached” due to the chipset attached processing unit 118 being attached to or included as part of the I/O expander 106 rather than the processing unit package 102 directly, and due to memory access requests from the chipset attached processing unit 118 being serviced by a controller of the I/O expander 106 and the chipset attached memory 108 rather than by a memory controller of the processing unit package 102 and the system memory 104. In terms of system topology, the chipset attached processing unit 118 is located across the chipset link 110 (e.g., communicably and/or physically) from the processing unit package 102 and the system memory 104—the chipset attached processing unit 118 is on a different side of the chipset link 110 from those components. It follows too that the chipset link 110 is on a same side of the chipset link 110 as the chipset attached memory 108 and the chipset attached memory controller 116.

With the chipset attached processing unit 118, the chipset attached memory 108 and the chipset attached memory controller 116 form a system (e.g., a sub-system, auxiliary system, or efficiency system) that is separate from the main system, where the main system includes the system memory 104, the processing unit 112, and the memory controller 114. In accordance with the described techniques, the chipset attached processing unit 118 is operable to execute tasks 120, such as one or more tasks managed by an application or program (not shown). The separate architecture allows the chipset attached processing unit 118 to execute or otherwise perform the tasks 120 using the chipset attached memory 108 and the chipset attached memory controller 116, without using the main system located across the chipset link 110, e.g., without using the processing unit package 102 and/or the system memory 104.

Due to this, power (and other resources) provided to the main system to operate it can be reduced while the chipset attached processing unit 118 performs the tasks 120 using the chipset attached memory 108 and the chipset attached memory controller 116. In one or more implementations, for instance, the processing unit package 102 and/or the system memory 104 are power gated so that those components are offline (e.g., completely powered down) while the chipset attached processing unit 118 performs at least one of the tasks 120. In this way, the processing unit package 102 and the system memory 104 consume less power (e.g., they do not consume any power) while the system continues to run, such as while the system continues to run using the chipset attached processing unit 118, the chipset attached memory controller 116, and the chipset attached memory 108 rather than using the processing unit package 102 and the system memory 104.

In at least one variation, tasks are allocated to the chipset attached processing unit 118 and the chipset attached memory 108 rather than to the processing unit 112 and the system memory 104 based on power consumption and/or computational complexity. In one implementation, for example, tasks that consume less power (and/or other computing resources) and/or are less computationally complex are allocated to the chipset attached processing unit 118 and the chipset attached memory 108, whereas tasks that consume more power (and/or other resources) and/or are more computationally complex (e.g., “power hungry” tasks) are allocated to the processing unit 112 and the system memory 104. By “allocated” it is meant that the tasks are scheduled and executed on the respective processing unit and by using the respective memory. In at least one scenario, examples of tasks that consume less power (and/or other computing resources) and/or are less computationally complex include, but are not limited to, video playback, web browsing, and implementation of a virtual machine, to name a few. Examples of tasks that consume more power (and/or other computing resources) and/or are more computationally complex include, but are not limited to, supporting computations of a physics engine during gaming, financial systems modeling, productivity application activities, content editing and/or modification activities, and so forth.

It is to be appreciated that in variations tasks are allocated to the processing unit 112 or to chipset attached processing unit 118 based on different factors than power consumption and/or computational complexity. In one or more implementations, a task is allocated to the chipset attached processing unit 118 or to the processing unit 112 based on a list which specifies which tasks (or types of tasks) are to be allocated to those processing units. For example, such a list indicates a destination for each task included in the list, e.g., either the processing unit 112 or the chipset attached processing unit 118. Alternatively or in addition, one or more characteristics of a task (e.g., as consuming more or less power) are determined, and the task is then allocated to the processing unit (e.g., the processing unit 112 or the chipset attached processing unit 118) designated for handling tasks having the determined characteristics.

In accordance with the described techniques, the chipset attached processing unit 118 performs the tasks 120, using the chipset attached memory 108 rather than using the system memory 104. The chipset attached memory 108 is physical memory managed by an application or program other than an operating system running on the processing unit 112. In one or more implementations, the chipset attached memory 108 is physical memory managed by an application, program, or operating system running on the chipset attached processing unit 118. Notably, the chipset attached memory 108 is separate from the system memory 104, allowing the chipset attached memory to be used in various manners, such as to speed up access to frequently used data, without reducing the amount of system memory 104 available to an operating system running on the processing unit 112.

The chipset attached memory 108 is any of a variety of types of physical memory. Examples of chipset attached memory 108 include random-access memory (RAM), such as DRAM, PCM, memristors, SRAM, and so forth. The chipset attached memory 108 is volatile memory or nonvolatile memory. The chipset attached memory 108 is packaged or configured in any of a variety of different manners. Examples of such packaging or configuring include a DIMM, a SO-DIMM, an RDIMM, an NVDIMM, a BGA, a 3-dimensional (3D) stacked memory, on-package memory (e.g., memory included in the I/O expander 106), memory permanently attached to (e.g., soldered to) the motherboard, and so forth.

As noted above, examples of types of DIMMs include, but are not limited to, SDRAM, DDR SDRAM, DDR2 SDRAM, DDR3 SDRAM, DDR4 SDRAM, and DDR5 SDRAM. In at least one variation, the chipset attached memory 108 is configured as or includes a SO-DIMM or an RDIMM according to one of the above-mentioned standards, e.g., DDR, DDR2, DDR3, DDR4, and DDR5. Further examples of chipset attached memory configurations include LPDDR, such as LPDDR2, LPDDR3, LPDDR4, and LPDDR5. It is to be appreciated that the chipset attached memory 108 is configurable in a variety of ways without departing from the spirit or scope of the described techniques.

In accordance with the described techniques, the processing unit 112 is configured to execute one or more tasks (not shown) using contents 122 from the system memory 104. For example, the processing unit 112 executes an application, program, and/or operating system (not shown) associated with the one or more tasks. Through the memory controller 114, the processing unit 112 accesses the contents 122 in the system memory 104 associated with performing the one or more tasks. In connection with performing such tasks, the system 100 supplies power to one or more of the processing unit package 102 (e.g., the processing unit 112 and/or the memory controller 114) and the system memory 104. In order to keep the contents 122 active in the system memory 104, for instance, the system memory 104 performs one or more self-refresh cycles, which involves application of at least some amount of voltage to the system memory 104.

In contrast to conventional techniques, however, one or more tasks are allocated to the chipset attached processing unit 118, such that those one or more tasks (e.g., the tasks 120) are performed by the chipset attached processing unit 118 using the chipset attached memory 108 rather than being performed by the processing unit 112 using the system memory 104. Said another way, the one or more tasks allocated to the chipset attached processing unit 118 are “offloaded” from the processing unit 112 and the system memory 104 across the chipset link 110 to the chipset attached processing unit 118 and the chipset attached memory 108. As such, when the tasks 120 that are allocated to the chipset attached processing unit 118 are being performed by the chipset attached processing unit 118, in one or more implementations, those tasks are not being performed by the processing unit 112. Due to this, the power (or some other parameter) supplied to the processing unit 112 and the system memory 104 is reduceable. In one or more implementations, for instance, the processing unit package 102 and the system memory 104 are power gated while the chipset attached processing unit 118 performs the tasks 120. For example, the processing unit package 102 and the system memory 104 are power gated so that they are completely powered down while the chipset attached processing unit 118 performs the tasks 120. In variations, rather than completely powering down the processing unit package 102 and/or the system memory 104, those components are operated with reduced resources (e.g., power) while the chipset attached processing unit 118 performs the tasks 120.

In order to perform the tasks 120, in one or more implementations, at least a portion of the contents 122 are transferred from the system memory 104 to the chipset attached memory 108. In accordance with the described techniques, the contents 122 are transferred from the system memory 104 via the chipset link 110 to the chipset attached memory 108.

Once the contents 122 are transferred to the chipset attached memory 108, the chipset attached processing unit 118 can perform the tasks 120 using the contents 122 from the chipset attached memory 108. For example, the chipset attached processing unit 118 executes (and/or continues execution of) one or more tasks 120 of an operating system and/or an application using the contents 122 from the chipset attached memory 108. Such tasks 120 are performed using the contents 122 from the chipset attached memory 108 rather than using the contents 122 from the system memory 104. Notably, this differs from scenarios where the processing unit 112 executes (and/or continues to execute) one or more tasks of an operating system and/or an application using the contents 122 from the chipset attached memory 108. Instead, control of performing the tasks is allocated to the chipset attached processing unit 118. This has the advantage of allowing the processing unit 112 (and other components of the main system) to be operated at a reduced level, which is effective to conserve resources, e.g., power. This also enables the chipset attached processing unit 118, the chipset attached memory controller 116, and the chipset attached memory 108 (e.g., a subsystem) to operate in isolation from the processing unit 112, the memory controller 114, and the system memory 104 (e.g., the main system). Further, in one or more scenarios, the system prevents communications across the chipset link 110 for a time period, which enables the “subsystem” to operate as a “sandbox” in isolation from the main system. In this way, the execution of the tasks 120 by the chipset attached processing unit 118 using the chipset attached memory 108 is isolated from the processing unit 112, the memory controller 114, and the system memory 104, such that any effects of the execution (e.g., negative effects) do not also affect (e.g., harm) the components across the chipset link 110 (e.g., the components of the main system).

In one or more implementations, the system 100 includes separate voltage rails (not shown) to the main system (e.g., the processing unit 112, the memory controller 114, and the system memory 104) and to the subsystem (e.g., the chipset attached processing unit 118, the chipset attached memory controller 116, and the chipset attached memory 108). Broadly, a power supply unit (PSU) is configured to supply power to the main system and the subsystem via the voltage rails. By using different rails, the PSU is operable to supply different amounts of power to the main system and to the subsystem, such as by supplying a first amount of power via a first voltage rail to the main system (e.g., none by power gating) and supplying a second amount of power via second voltage rail to the subsystem (e.g., an default operating amount). In variations, the system 100 is configured differently to obtain advantages by allocating different tasks and/or different types of tasks to the processing unit 112 or the chipset attached processing unit 118.

The system 100 is implementable in any of a variety of different types of apparatuses and/or computing devices. For example, the system 100 is implementable in a device or apparatus such as a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, and an automotive computer, to name just a few. In one or more implementations, for example, the system 100 is packaged as an apparatus, and the apparatus is a printed circuit board (PCB), such that the printed circuit board includes the main system (e.g., at least the processing unit 112 and the system memory 104), the chipset link 110, and the sub-system (e.g., at least the chipset attached processing unit 118 and the chipset attached memory 108). In variations, the system 100 is an apparatus and the apparatus includes a plurality of printed circuit boards, such that the main system is implemented on a first printed circuit board and the sub-system is implemented on a second printed circuit board. As noted above and below, in variations, the system 100 includes multiple sub-systems, such that in at least one of those variations, the apparatus includes at least three printed circuit boards, e.g., a first for the main system, a second for the sub-system, and at least a third for at least a third sub-system. Although a one-to-one correspondence between printed circuit boards and the main system and each sub-system is discussed just above, in variations, there is less than a one-to-one correspondence, e.g., the main system and the sub-system share a printed circuit board or multiple sub-systems share a circuit board. Alternatively or additionally, the apparatus is a computing device, some examples of which are mentioned just above.

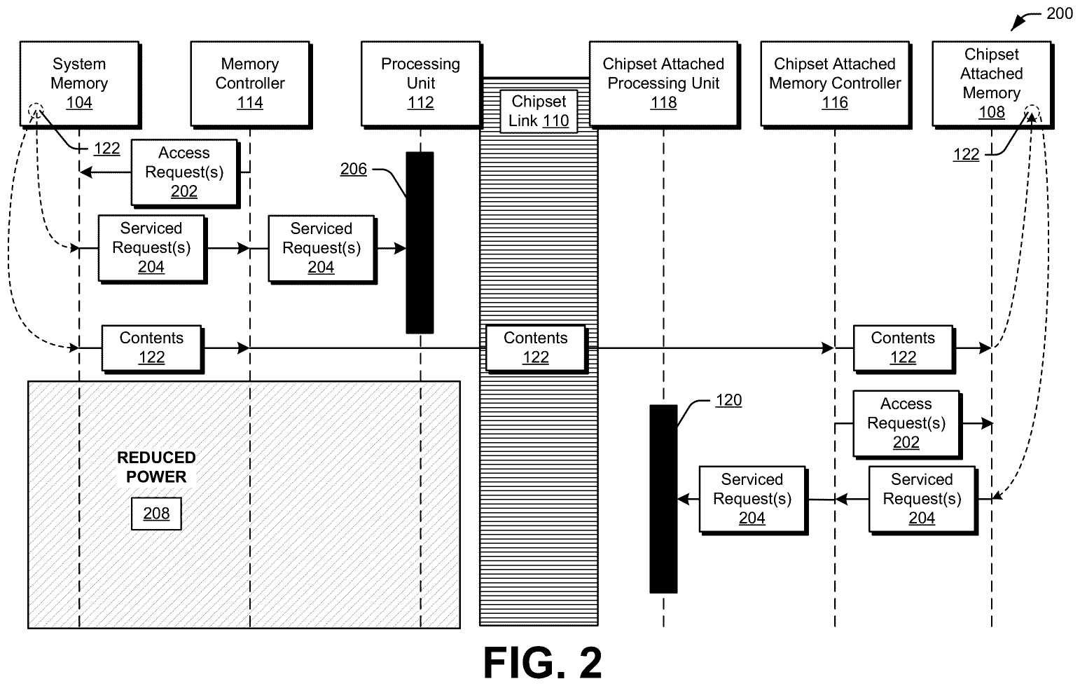

FIG. 2 depicts a non-limiting example 200 in which tasks are allocated to a chipset attached processing unit located across a chipset link from a system memory. The example 200 includes the system memory 104, the memory controller 114, the processing unit 112, the chipset link 110, the chipset attached processing unit 118, the chipset attached memory controller 116, and the chipset attached memory 108.

The example 200 includes a variety of example communications and operations between the system memory 104, the memory controller 114, the processing unit 112, the chipset link 110, the chipset attached processing unit 118, the chipset attached memory controller 116, and the chipset attached memory 108 over time. In this example 200, the communications and operations are positioned vertically based on time, such that communications and operations closer to a top of the example occur prior to communications or operations further from the top of the example. It follows also that communications or operations closer to a bottom of the example occur subsequent to communications or operations further from the bottom. The example 200 also depicts various phases and/or states of the system 100 or portions of the system 100. These phases and/or states are also positioned in the example 200 vertically based on time, such that phases or states closer to a top of the example occur prior to phases, states, or communications further from the top.

Here, the illustrated example 200 depicts the system memory 104 receiving one or more access requests 202 (e.g., read and/or write requests) from the memory controller 114. The illustrated example 200 also depicts the memory controller 114 receiving one or more serviced requests 204 from the system memory 104. Where an access request 202 corresponds to a read request, for instance, the respective serviced request 204 includes or otherwise indicates data of one or more memory addresses associated with the access request 202. In contrast, where an access request 202 corresponds to a write request, the respective serviced request 204 involves updating the system memory 104 at one or more memory addresses associated with the write request, such as to store one or more indicated values.

The illustrated example 200 also depicts the contents 122 in the system memory 104. In one or more variations, the access requests 202 transmitted by the memory controller 114 are serviced using the contents 122 in the system memory 104. Thus, the contents 122 in the system memory 104 are depicted with the dashed arrow as being used for the serviced requests 204 provided to the memory controller 114. In accordance with the described techniques, the access requests 202 and the serviced requests 204 between the system memory 104 and the memory controller 114 are performed in connection with execution of one or more tasks 206 by the processing unit 112. As noted above, the tasks 206 (and/or types of tasks) performed by the processing unit 112 differ in one or more implementations from the tasks 120 (and/or types of tasks) performed by the chipset attached processing unit 118. In one example, for instance, the tasks 206 performed by the processing unit 112 using the contents 122 from the system memory 104 are relatively “power hungry” tasks, e.g., they consume more power and/or other resources than the tasks 120 performed by the chipset attached processing unit 118.

Although transmission of the access requests 202 and the servicing of them (e.g., as indicated by the serviced requests 204) by the memory controller 114 and the system memory 104 is depicted prior in time to the transmission of the access requests 202 and the servicing of them (e.g., as indicated by the serviced requests 204) by the chipset attached memory controller 116 and chipset attached memory 108, in one or more scenarios, transmission of the access requests 202 and the servicing of them (e.g., as indicated by the serviced requests 204) by the memory controller 114 and the system memory 104 is occurs subsequent in time to the transmission of the access requests 202 and the servicing of them (e.g., as indicated by the serviced requests 204) by the chipset attached memory controller 116 and chipset attached memory. In other words, in one or more implementations, the processing unit 112 performs the tasks 206 using the contents 122 from the system memory 104 and, subsequently, the chipset attached processing unit 118 performs the tasks 120 using the contents 122 from the chipset attached memory 108, which may be the same or different from the contents 122 in the system memory 104. And in one or more other implementations, the chipset attached processing unit 118 performs the tasks 120 using the contents 122 from the chipset attached processing unit 118 and, subsequently, the processing unit 112 performs the tasks 206 using the contents 122 from the system memory 104.

In one or more implementations, the memory controller 114 signals the system memory 104 (e.g., one or more write requests) to transfer the contents 122 or a portion of the contents 122. For example, memory controller 114 initiates a transfer of the contents 122 or a portion of the contents 122 maintained by the system memory 104 to the chipset attached memory 108. In variations, the contents 122 transferred ranges from a subset of data maintained in the system memory 104 to an entirety of the data maintained in the system memory 104. In terms of data flow, the contents 122 are transferred from the system memory 104 (e.g., over one or more memory interfaces) to the memory controller 114, which communicates the contents 122 over the chipset link 110 to the chipset attached memory controller 116 (e.g., of the I/O expander 106), and the chipset attached memory controller 116 communicates the contents 122 to the chipset attached memory 108 (e.g., over one or more memory interfaces), where the contents 122 are stored. In one or more implementations, the chipset attached memory controller 116 stores the contents 122 in the chipset attached memory 108 using one or more write requests.

Once the contents 122 are stored in the chipset attached memory 108, the chipset attached processing unit 118 is operable to perform the tasks 120 using the contents 122 from the chipset attached memory 108. Here, the action of storing the contents 122 in the chipset attached memory 108 is represented by the dashed arrow to the contents 122 in the chipset attached memory 108.

The performance of the tasks 120 using the contents 122 from the chipset attached memory 108 is illustrated, in part, by the chipset attached memory 108 receiving one or more access requests 202 (e.g., read and/or write requests) from the chipset attached memory controller 116. The illustrated example 200 also depicts the chipset attached memory controller 116 receiving one or more serviced requests 204 from the chipset attached memory 108. Where an access request 202 corresponds to a read request, for instance, the respective serviced request 204 includes or otherwise indicates data of one or more memory addresses associated with the access request 202. In contrast, where an access request 202 corresponds to a write request, the respective serviced request 204 involves updating the chipset attached memory 108 at one or more memory addresses associated with the write request, such as to store one or more indicated values.

As noted above, the illustrated example 200 also depicts the contents 122 in the chipset attached memory 108, which are the same or different from those in the system memory 104 in variations. In accordance with the described techniques, the access requests 202 transmitted by the chipset attached memory controller 116 are serviced using the contents 122 in the chipset attached memory 108. Thus, the contents 122 in the chipset attached memory 108 are depicted with the dashed arrow as being used for the serviced requests 204 provided to the chipset attached memory controller 116.

In accordance with the described techniques, the access requests 202 and the serviced requests 204 between the chipset attached memory 108 and the chipset attached memory controller 116 are performed in connection with execution of one or more of the tasks 120 by the chipset attached processing unit 118. As noted above, the tasks 120 (and/or types of tasks) performed by the chipset attached processing unit 118 differ, in one or more implementations, from the tasks 206 (and/or types of tasks) performed by the processing unit 112. In one example, for instance, the tasks 120 performed by the chipset attached processing unit 118 using the contents 122 from the chipset attached memory 108 are relatively “simple” in terms of computational complexity, e.g., they consume less power and/or other resources than the tasks 206 performed by the chipset attached processing unit 118.

The example 200 also depicts a reduced power state 208 of the system memory 104, the memory controller 114, and the processing unit 112. In one or more implementations, the system 100 reduces the power supplied to the main system (e.g., the system memory 104, the memory controller 114, and the processing unit 112) while the chipset attached processing unit 118 performs the tasks 120 using the contents 122 in the chipset attached memory 108. For example, the system 100 power gates the main system (e.g., completely shuts off power to the main system) while the chipset attached processing unit 118 performs the tasks 120 using the contents 122 in the chipset attached memory 108. Although operating the main system in a reduced power mode is discussed throughout, in one or more implementations, both the main system and the subsystem operate concurrently, such that the processing unit 112 performs the tasks 206 using the contents 122 from the system memory 104 while at a same time the chipset attached processing unit 118 performs the tasks 120 using the contents 122 from the chipset attached memory 108. Additionally or alternatively, system 100 reduces the power supplied to the subsystem (e.g., the chipset attached processing unit 118, the chipset attached memory controller 116, and the chipset attached memory 108) while the processing unit 112 performs the tasks 206 using the contents 122 from the system memory 104.

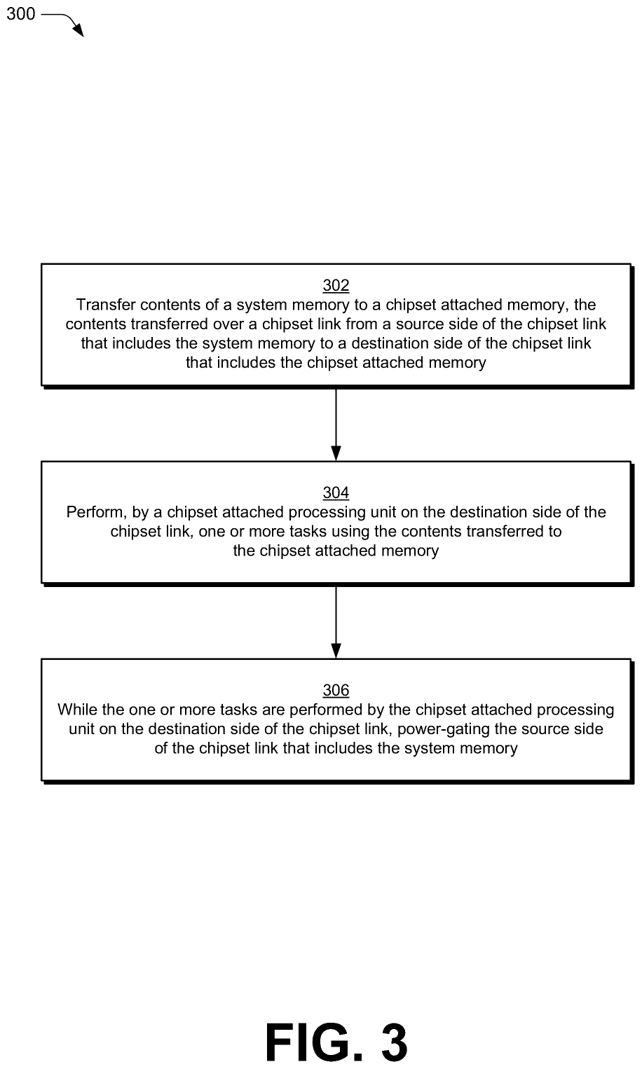

FIG. 3 depicts a procedure in an example 300 implementation of task allocation with chipset attached memory and additional processing unit.

Contents of a system memory are transferred to a chipset attached memory (block 302). In accordance with the principles discussed herein, the contents are transferred over a chipset link from a source side of the chipset link that includes the system memory to a destination side of the chipset link that includes the chipset attached memory. By way of example, at least a portion of the contents 122 are transferred from the system memory 104 to the chipset attached memory 108. In accordance with the described techniques, the contents 122 are transferred from the system memory 104 via the chipset link 110 to the chipset attached memory 108.

One or more tasked are performed by a chipset attached processing unit on the destination side of the chipset link using the contents transferred to the chipset attached memory (block 304). By way of example, once the contents 122 are transferred to the chipset attached memory 108, the chipset attached processing unit 118 can perform the tasks 120 using the contents 122 from the chipset attached memory 108. For example, the chipset attached processing unit 118 executes (and/or continues execution of) one or more tasks 120 of an operating system and/or an application using the contents 122 from the chipset attached memory 108. Such tasks 120 are performed using the contents 122 from the chipset attached memory 108 rather than using the contents 122 from the system memory 104.

While the one or more tasks are performed by the core on the destination side of the chipset link, the source side of the chipset link that includes the system memory is power-gated (block 306). By way of example, the processing unit package 102 and the system memory 104 are power gated while the chipset attached processing unit 118 performs the tasks 120. For example, the processing unit package 102 and the system memory 104 are power gated so that they are completely powered down while the chipset attached processing unit 118 performs the tasks 120. In variations, rather than completely powering down the processing unit package 102 and/or the system memory 104, those components are operated with reduced resources (e.g., power) while the chipset attached processing unit 118 performs the tasks 120.

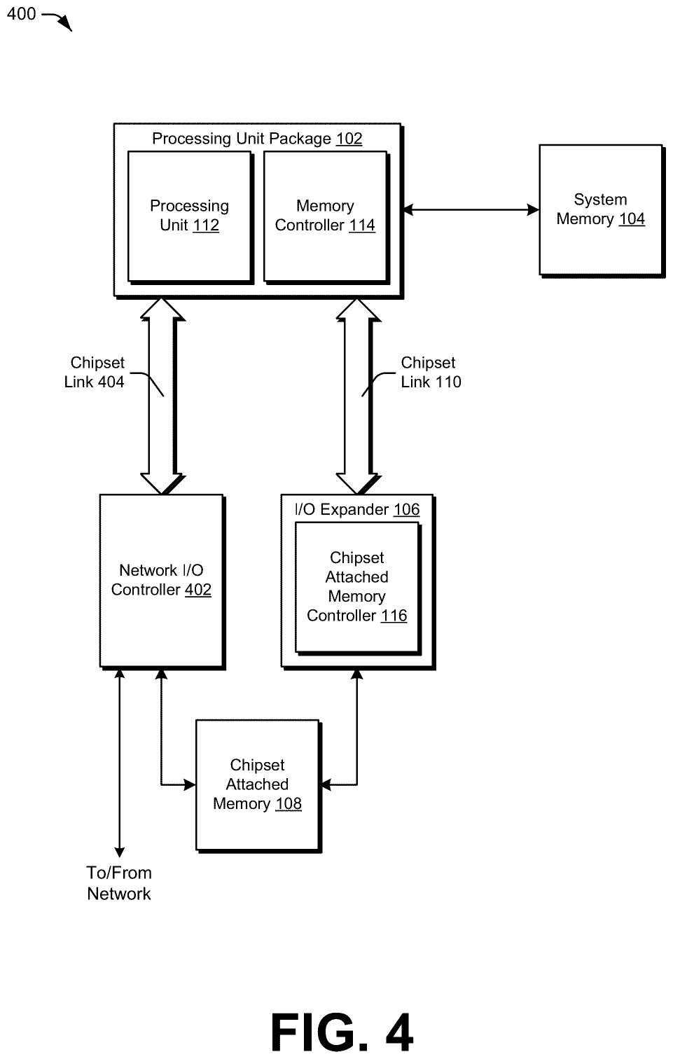

FIG. 4 is an illustration of another non-limiting example system 400 that employs a chipset attached memory and additional processing unit for task allocation. The system 400 includes the processing unit package 102, the system memory 104, the I/O expander 106, the chipset attached memory 108, and the chipset link 110 analogous to the system 100 of FIG. 1. The system 400 also includes a network I/O controller 402 and a chipset link 404 allowing the processing unit package 102 to communicate with the network I/O controller 402 using any of a variety of communication links analogous to chipset link 110.

The processing unit package 102, the system memory 104, the I/O expander 106, the chipset attached memory 108, the chipset link 110, the network I/O controller 402, and the chipset link 404 are installed on or are part of, for example, a motherboard or other printed circuit board. In one or more implementations, the I/O expander 106 (including the chipset attached memory controller 116), the chipset link 110, the chipset link 404, one or more memory channels between the processing unit package 102 and the system memory 104, and one or more memory channels between the I/O expander 106 and the chipset attached memory 108 are also referred to as a chipset of a motherboard or other printed circuit board.

The processing unit package 102 includes the processing unit 112 and the memory controller 114. Although a single processing unit 112 is illustrated in the system 400, the processing unit package 102 optionally includes any number of processing units of the same or different types, and or other types of components, such as an artificial intelligence accelerator. Given this architecture, such other optional components also access the system memory 104 directly (e.g., via the memory controller 114) or through an operating system running on the processing unit 112. Those components are also configured to access the chipset attached memory 108 (e.g., via the I/O expander 106 or the network I/O controller 402).

The network I/O controller 402 manages communication over a network, such as by sending data or control signals to one or more other devices via the network and receiving data or control signals from one or more other devices via the network. The network is implemented in any of a variety of manners, such as an Ethernet network, an InfiniBand network, and so forth. The network I/O controller 402 is also coupled or attached to the chipset attached memory 108 via one or more memory channels. In one or more implementations, the chipset attached memory 108 is address space (e.g., PCIe address space) that is addressable by other server nodes as well as components of the system 400 (e.g., the processing unit 112). The network I/O controller 402 is thus able to send read and write requests to the chipset attached memory 108 and receive responses from the chipset attached memory 108, analogous to the chipset attached memory controller 116.

In one or more implementations the chipset attached memory 108 is attached or coupled to only one of the network I/O controller 402 or the I/O expander 106 rather than attached or coupled to both the network I/O controller 402 and the I/O expander 106.

The network I/O controller 402 being attached or coupled to the chipset attached memory 108 supports various different usage scenarios. In one or more implementations, the processing unit package 102 is able to access the chipset attached memory 108 via the network I/O controller 402, allowing the chipset attached memory 108 to be used in situations where the chipset attached memory 108 is not attached or coupled to the I/O expander 106. Such situations arise, for example, where board routing limitations prevent the chipset attached memory 108 from being attached or coupled to the I/O expander 106.

In one or more implementations, the network I/O controller 402 allows the chipset attached memory 108 to be accessed by other devices via the network. This access is allowed using any of a variety of public or proprietary remote direct memory access (RDMA) techniques. For example, assume the system 400 is implemented in a server node connected to multiple other server nodes (e.g., some including their own chipset attached memory and optionally others not including their own chipset attached memory). Another server node communicates read and write requests to the chipset attached memory 108 via the network I/O controller 402 and receives responses from the chipset attached memory 108 via the network I/O controller 402. The other server node is thus able to make use of the chipset attached memory 108 without disrupting the system memory 104 or even the processing unit package 102. E.g., the processing unit package 102 need not have knowledge of the other server node accessing the chipset attached memory 108.

By way of another example, assume the system 400 is implemented in a server node connected to multiple other server nodes, at least one of which includes its own chipset attached memory. In at least one variation, the processing unit 112 (or other component of the processing unit package 102) is able to communicate read and write requests to the chipset attached memory of the other server node via the network I/O controller 402 and receive responses from the chipset attached memory of the other server node via the network I/O controller 402. The processing unit 112 or other component of the processing unit package 102 is thus able to make use of the chipset attached memory of another sever node without disrupting the system memory 104 or the chipset attached memory 108.

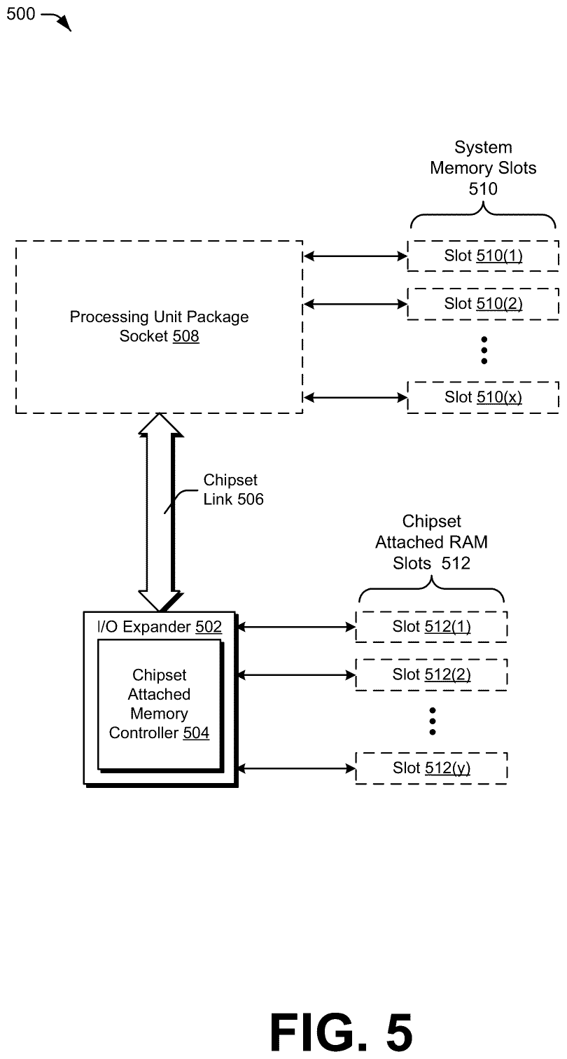

FIG. 5 is an illustration of another non-limiting example system 500 employs a chipset attached memory and additional processing unit for task allocation. The system 500 is, for example, a motherboard or other printed circuit board. The system 500 includes an I/O expander 502 that includes a chipset attached memory controller 504, and a chipset link 506. The system 500 also includes a processing unit package socket 508, system memory slots 510, and chipset attached memory slots 512. The processing unit package socket 508 is designed to have a processing unit package, such as the processing unit package 102 of FIG. 1 or FIG. 4, installed or inserted therein. In one or more implementations, the I/O expander 502 (including the chipset attached memory controller 504), the chipset link 506, one or more memory channels between the processing unit package socket 508 and the system memory slots 510, and one or more memory channels between the I/O expander 502 and the chipset attached memory slots 512 are also referred to as a chipset of a motherboard or other printed circuit board.

The I/O expander 502 is an I/O expander analogous to the I/O expander 106 of FIG. 1 or FIG. 4. The chipset attached memory controller 504 is a chipset attached memory controller analogous to the chipset attached memory controller 116 of FIG. 1 or FIG. 4. The chipset link 506 is analogous to the chipset link 110 of FIG. 1 or FIG. 4.

The system memory slots 510 include multiple (“x”) memory slots 510(1), 510(2), . . . , 510(x). The system memory slots 510 are designed to have system memory, such as the system memory 104 of FIG. 1 or FIG. 4, installed or inserted therein. The system memory slots 510 are, for example, DIMM, SO-DIMM, or RDIMM slots. Although multiple memory slots 510(1), 510(2), . . . , 510(x) are illustrated, the system 500 optionally includes a single memory slot 510 or any other number of memory slots 510.

The chipset attached memory slots 512 include multiple (“y”) slots 512(1), 512(2), . . . , 512(y). The chipset attached memory slots 512 are designed to have chipset attached memory, such as the chipset attached memory 108 of FIG. 1 or FIG. 4, installed or inserted therein. The chipset attached memory slots 512 are, for example, DIMM, SO-DIMM, or RDIMM slots. Although multiple memory slots 512(1), 512(2), . . . , 512(y) are illustrated, the system 500 optionally includes a single memory slot 512 or any other number of memory slots 512.

With a processing unit package installed or inserted in the processing unit package socket 508, system memory installed or inserted in the system memory slots 510, chipset attached memory installed or inserted in the chipset attached memory slots 512, and additional I/O devices (e.g., a chipset attached nonvolatile memory and/or a chipset attached disk drive) optionally installed or otherwise coupled to the I/O expander 502, the system 500 becomes the system 100 of FIG. 1 or a system having tiered memory options.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the system memory 104, the chipset link 110, and the chipset attached memory 108) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. An apparatus comprising:
a main system that includes at least a processing unit and a system memory;
a sub-system that includes a chipset attached processing unit and a chipset attached memory, wherein the chipset attached processing unit is configured to perform one or more tasks using the chipset attached memory; and
a chipset link that couples the main system to the sub-system.

2. The apparatus of claim 1, wherein contents of the system memory are transferable to the chipset attached memory of the sub-system via the chipset link to enable the chipset attached processing unit to perform the one or more tasks using the contents from the chipset attached memory.

3. The apparatus of claim 2, wherein the main system further includes a memory controller, wherein the memory controller is configured to signal the system memory to transfer the contents to the chipset attached memory.

4. The apparatus of claim 2, wherein the processing unit and the system memory are power gated while the chipset attached processing unit performs the one or more tasks using the chipset attached memory.

5. The apparatus of claim 4, wherein the power gating causes the main system to be completely shut off while the chipset attached processing unit performs the one or more tasks using the chipset attached memory.

6. The apparatus of claim 4, wherein the power gating causes the main system to operate in a reduced power mode while the chipset attached processing unit performs the one or more tasks using the chipset attached memory.

7. The apparatus of claim 1, wherein the processing unit is configured to perform additional tasks using additional contents from the system memory while the chipset attached processing unit performs the one or more tasks using the chipset attached memory.

8. The apparatus of claim 1, wherein the one or more tasks are allocated to the chipset attached processing unit and the chipset attached memory based on a power consumption of the one or more tasks.

9. The apparatus of claim 1, wherein the one or more tasks are allocated to the chipset attached processing unit and the chipset attached memory based on a computational complexity of the one or more tasks.

10. The apparatus of claim 1, wherein the one or more tasks are allocated to the chipset attached processing unit and the chipset attached memory based on a list which specifies types of tasks to be allocated to the chipset attached processing unit and the chipset attached memory.

11. The apparatus of claim 1, further comprising at least one additional sub-system that includes at least an additional chipset attached processing unit and an additional chipset attached memory, wherein the additional chipset attached processing unit is configured to perform one or more additional tasks using the additional chipset attached memory.

12. A method comprising:
transferring contents of a system memory to a chipset attached memory, the contents transferred over a chipset link from a source side of the chipset link that includes the system memory to a destination side of the chipset link that includes the chipset attached memory;
performing, by a chipset attached processing unit on the destination side of the chipset link, one or more tasks using the contents transferred to the chipset attached memory; and
while the one or more tasks are performed by the chipset attached processing unit on the destination side of the chipset link, power-gating the source side of the chipset link that includes the system memory.

13. The method of claim 12, further comprising:
powering on the source side that includes the system memory; and
performing, by a processing unit included on the source side, one or more additional tasks using the contents of the system memory.

14. The method of claim 12, wherein performing the one or more tasks by the chipset attached processing unit on the destination side of the chipset link reduces power consumption.

15. A system comprising:
a processing unit;
a system memory;
a chipset attached processing unit;
a chipset attached memory; and
a memory controller, wherein the memory controller is configured to initiate a transfer of contents stored in the system memory to the chipset attached memory.

16. The system of claim 15, wherein the chipset attached processing unit is configured to perform one or more tasks using the contents of the chipset attached memory.

17. The system of claim 16, wherein the processing unit and the system memory are power gated while the chipset attached processing unit performs the one or more tasks using the chipset attached memory.

18. The system of claim 17, wherein the power gating causes the processing unit and the system memory to be completely shut off while the chipset attached processing unit performs the one or more tasks using the chipset attached memory.

19. The system of claim 15, further comprising a chipset link, wherein the memory controller is configured to transfer the contents stored in the system memory to the chipset attached memory via the chipset link.

20. The system of claim 15, wherein the memory controller is further configured to allocate tasks to the chipset attached processing unit and the chipset attached memory based on a power consumption or computational complexity of the tasks.
